(19) United States
(12) Patent Application Publication
(10) Pub. No.: US 2003/0074266 A1
(43) Pub. Date: Apr. 17, 2003

(54) "E-record/card" or online record/card comprising a combined record and greeting card

(76) Inventor: Alan Lorber, New York, NY (US)

Correspondence Address: ALAN LORBER, 414 E. 52 ST., NEW YORK, NY, 10022, US

(21) Appl. No.: 09/975,575

(22) Filed: Oct. 12, 2001

(51) Int. Cl. G06F 17/60

(52) U.S. Cl. 705/26

(57) ABSTRACT

An “E-RECORD/CARD” as a combined record and greeting card sold and purchased online over computer based communications networks e.g. the Internet, the methods, processes and marketing thereof. An internet buyer online chooses via seller's website from various displays of “e-record/card” inventory for sale, comprising description of the elements contained, such as recording and card's sentiment, and further comprising interfaces for on-line display, selection, transaction, distribution, sending and receiving.

### CROSS REFERENCE TO RELATED APPLICATIONS

U.S. Pat. No. 6,003,254: “Combined Greeting Card and Records Sleeve” (“the Patent”) with reference to and as it pertains to present invention.

Disclosure Document No. 500562 with reference to and as it pertains to “the Patent” and to the present invention.

### SUMMARY OF INVENTION

Definitions and terms pertaining to present invention as used in the following Summary hereto:

(1) “e-greeting card”: greeting cards sold online.

(2) “e-record”: records sold online, or any sound recording sold online or CD-Rom or DVD of any configuration, language, genre or from any source whatsoever.

(3) “e-record/card”: the present invention (combined e-record and e-greeting card) as it pertains to “the Patent ” in the form, methods and various configurations described that is sold online.

(4) “the Patent”. an assembled or fabricated pre-manufactured version of an “e-record/card” (the present invention) as is fully described and illustrated in the above referenced U.S. Pat. No. 6,003,254, which is sold via “brick & mortar” retail outlets. This combined greeting card and record sleeve is a side-fold card design consisting of a front-sheet and a back-sheet of cardboard material, incorporating in the front sheet a phonographic record-sleeve as a pocket which is adapted to receive an audio disc, employing a top opening which is adapted to be of sufficient length to correspond to the pre-determined dimension of the audio disc received, and a die-cut adapted to expose indicia on the disc received; with the back-sheet of relative size and dimension to the front-sheet on which is contained on an inside panel general greeting card indicia. Such indicia, more directly, the greeting card's sentiment, reflects a portion of the lyric of the song contained on the audio disc which is received in the record-sleeve, or other indicia reflective of the disc contained in the receiving sleeve.

(5) “hard-copy”: fully fabricated “e-records/card”.

(6) “soft-copy”: unfabricated and “cut-out” versions of “e-record/card”

(7) “cut-out”: template of unfabricated “e-record/card” imprinted on card-stock and “punch-out”-ready.

(8) “animated e-record/card”: animated audio/visual version of the present invention

“The patent”, the Combined Greeting Card & Record Sleeve is a Record/Card product application for selling records in greeting cards, and a product application for selling greeting cards that contain records. Its primary retail outlets are traditional channels e.g. “brick & mortar” record store and card store sales outlets, card industry retail partners, etc, with ancillary expansions or spin-offs in music promotions, sports, subscription, charitable and institutional-licensing. “The patent” provides both the greeting card and record industries a new worldwide source of inventory resulting in high profitability-potential over and above its core-businesses and is the basis of the present invention.

Each record label or music group or each greeting card company having adapted “the patent” self-generates its own record/card catalogues drawing on back-catalogue titles and current titles, marketed independent of or in conjunction with the sales, distribution and manufacturing channels of the other. Both back-catalogue titles (a.k.a “oldies”) and greeting cards appeal to sentimental values. The Record/Card (“the patent”) provides remarkable sales-potential for this genre in the two concerned multi-billion dollar industries. It recalls a time when a memory is shared with a song, a meaningful sentimental gift in a card.

Selling current “singles” audio product in the record/card provides additional revenue-potential. It also provides loyal record-fans with a “personal” message and photo from their favorite stars along with the caring from-me-to-you personal sentiment: e.g. “I love you.” (signed) Ricky! The Record/Card (“the patent”) is also adapted to sports-licensing and other events, to include on an inside panel of the record/card a ticket pocket that acts as a personal special-invitation to events (like a “date-card”) a marketing tool for industry functions and charities, benefits and further comprising sporting-events (“take me out to the ballgame”) and further providing new stadium venue sales, team-based retailing and cross-marketing to sporting-goods and food tie-ins.

The Record/Card is adaptable to “subscription-licensing” defined as licensing to any organization having membership lists, subscribers, as also further defined as “cultural licensing”, for symphonies, ballet, opera companies, “new season samplers”.

Similarly, on an institutional basis the combined record and greeting card provides auto-industries premiums on behalf of dealers and owners, good-will banking and insurance, self liquidators and premiums, multimedia information retrieval and interactive programs, and all importantly, charitable and patriotic fund raising, the “God Bless America”/symbol of America card.

The present invention “E-RECORD/CARD” sold over the Internet is the electronic version of “the Patent” on the web-sites of the product manufacturers, providing “.com”-sales that greatly impact profitability over and above core-business and distribution.

The present invention provides the means and methods on how to impact internet-based sales via worldwide communications network. The online greeting-card buyer is also already used to buying records on line. It is a simple step to also accept buying online a record combined with a greeting card as a unique gift or keepsake..

However, although significant online-sales have occurred is selling records online and selling greeting cards online this vast consumer base heretofore could only purchase either records or greeting cards online. Greeting Card and Record manufacturer's web-sites either respectively sold records or greeting cards online, but never a combined record and greeting card.

### DETAILED DESCRIPTION

The present invention provides an e-commerce form of “the patent”, the inventory, configurations, methods of sale and purchase. For the online seller, the present invention comprises all the essential elements and means and methods to achieve sale, distribution and marketing, further providing ancillary applications possible and expanded brand-recognition For the buyer, the present invention provides easy accessibility online-purchase, content, and flexibility in choosing, receiving, sending and/or transmitting the “e-record/card” product.

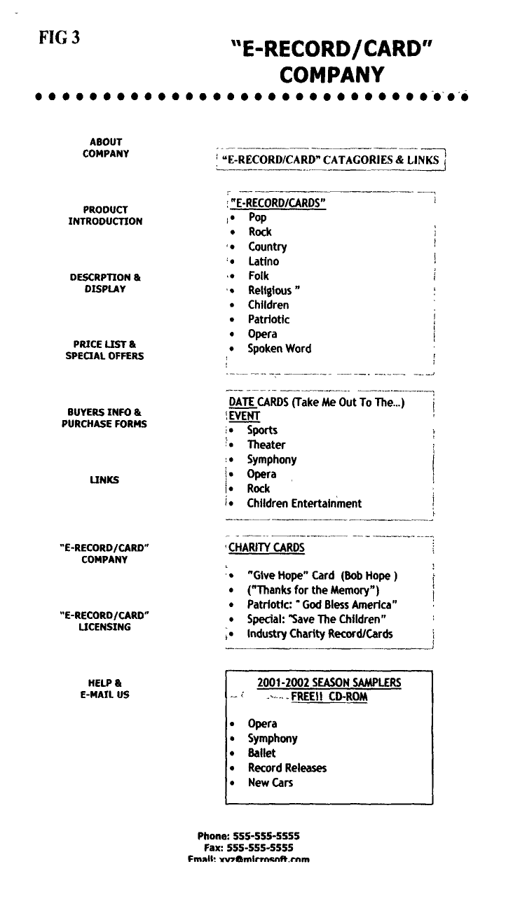

FIG. 3 of the present invention generally illustrates a commercial transaction web page from both the buyer's and seller's perspectives in accordance with the present invention, enabling the buyer to obtain information about the seller, the product, choose from categories of product offered, links to displays and further product-information, pricing and general methods to complete purchase of goods. From a seller's perspective, it provides company information, product, categorization, pricing, transaction systems, and further provides e-business-to-business links and “e-record/card” licensing product-applications.

An internet buyer online chooses from various displays of “e-record/card” inventory for sale, comprising description of the recording, card's sentiment as dictated by the song contained on the “e-recording”, and further comprising interfaces and hyperlinks for on-line display, selection, transaction and sending/receiving present invention. The nature of electronic transaction hereto, flow-charting, displaying, distribution of goods from buyer to seller, etc, as may be further modified should be construed as included within the scope of the invention which would be apparent to those skilled in the art.

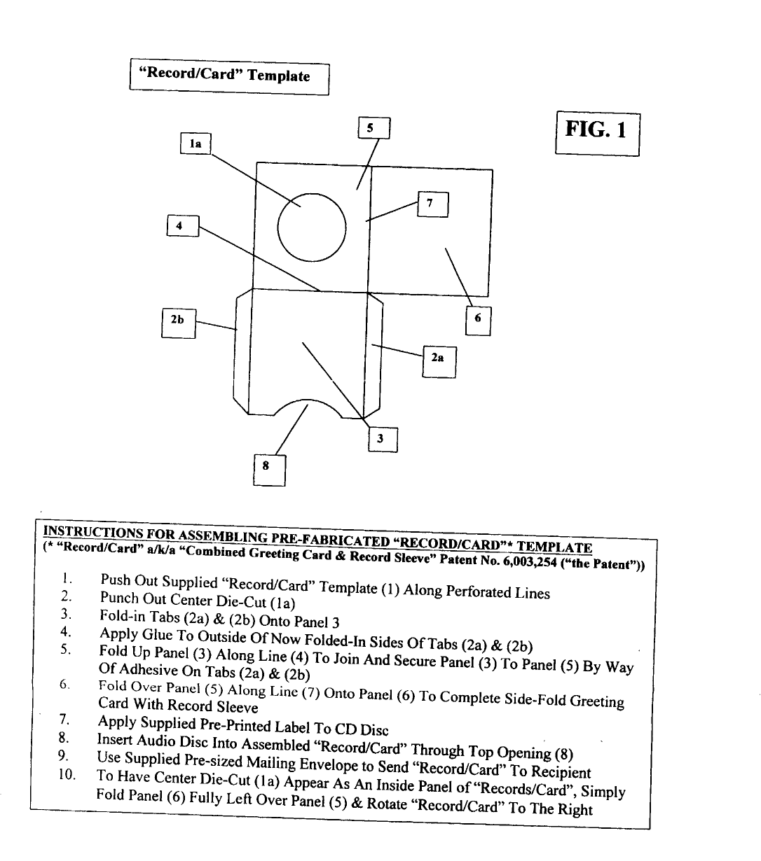

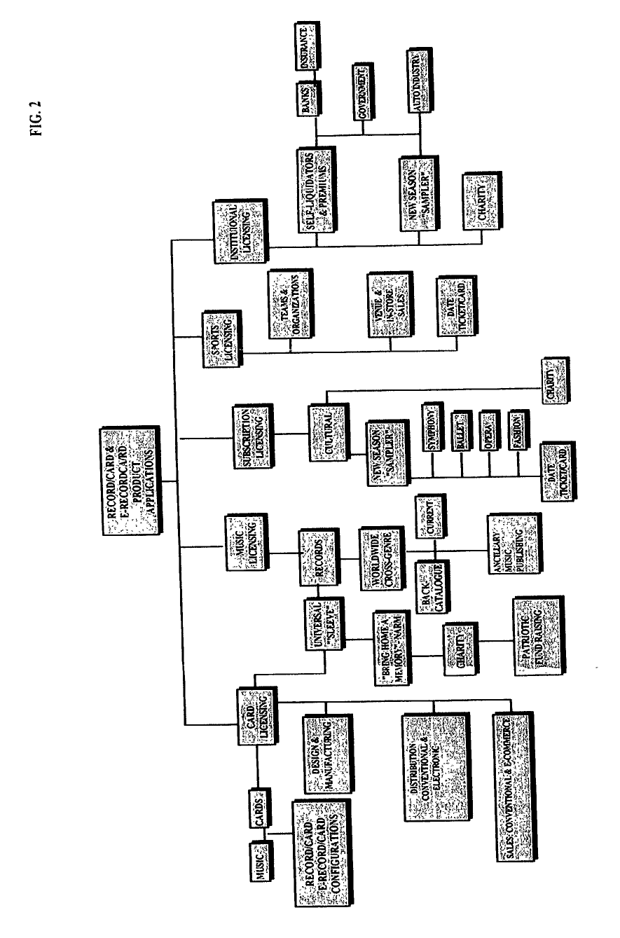

FIG. 1 in the event of a buyers choice to purchase “e-record/card” in an unfabricated form, more fully described in the Summary, provides instructions for assembling the “record/card” template in a step-by-step method as illustrated by a numbering system which coincides with various elements of the template drawing shown (not necessarily to scale), which when followed will results in an assembled “record/card”. This assembled “record/card duplicates (FIG. 1) and (FIG. 2) of “the patent”, it's descriptions and embodiments thereof FIG. 2 from the sellers perspective, is a schematic of the licensing, manufacturing, and transactional applications possible utilizing the present invention and “the patent” counterpart more fully described in the Summery. This diagrammatic organizational-view as may be further modified should be construed as included within the scope of the invention which would be apparent to those skilled in the art.

While this invention has been described as having an exemplary design, the present invention may be further modified within the spirit and scope of this disclosure. This application is therefore intended to cover any variations, uses or adaptations of the invention using its general principles. Further, this application is intended to cover such departures from the present disclosure as come within known or customary practice in the art to which this invention pertains.

What I claim is:

1] An “e-record/card” as a combined “e-record” and “e-greeting card” the resulting new e-commerce inventory; the methods and processes of sales and marketing thereto via internet based systems over computer networks and/or via traditional “brick and mortar” sales outlets.

2] The idea according to claim 1 of combining an “e-record” and an “e-greeting card”.

3] A method according to claim 1 wherein an “e-record” and “e-greeting card” are combined, comprising establishing criteria for greeting card manufacturers in determining catalogues of such new “e-record/card” inventory.

4] A method according to claim 3 wherein this new “e-record/card” inventory is created comprising determining audio elements chosen for the “e-record/card” new inventory; wherein textual elements chosen for the “e-record/card” new inventory; wherein design elements are chosen for the “e-record/card” new inventory.

5] A method according to claim 4 wherein design of new “e-record/card” inventory is created

6] A method according to claim 4 further comprising establishing a distribution center for electronically stored catalogues of such music, textual and design elements; providing an interface comprising methods of enabling a buyer to select such elements which when combined result in the present invention

7] A method according to claim 1 wherein new “e-record/card” inventory is displayed via on-screen thumbnails or other display devices in its various available forms and configurations which include the fabricated “record/card” (the patent” a.k.a “hard copy” the “e-record/card” (the present invention); or the present invention in its “animated e-record/card” form; and the present invention in its unfabricated “soft-copy” form comprising “record/card” “cut-out”, audio elements, CD label and mailing supplies.

8] A method according to claim 7 wherein a pre-purchase sample of the various forms and configurations is provided for buyers viewing and/or audio auditioning either via a downloading interface and/or instant auditioning via purchaser's computer audio/visual devices

9] A method according to claim 7 further comprising an interface enabling buyer to purchase such goods from seller of purchaser's selected forms and/or configuration via a transactional purchasing system

10] A method according to claim 7 providing an interface enabling buyer to designate recipient of the “e-record/card” configuration, for receipt via conventional postal systems or via internet and/or computer network e-mail communications systems.

11] A method according to claim 6 of mailing “e-record/card” configuration to purchaser via distribution center

12] A method according to claim 6 and claim 9 of transmitting “e-record/card” configurations.

13] A method according to claim 10 of retrieving “e-record/card” received via internet and/or computer network e-mail communications systems.

14] A method according to claim 6 of providing an interface comprising methods of downloading, printing and saving “soft-copy” elements of the “e-record/card” and further comprising interface to download audio file via digital encoding and downloading devices, downloading of preprinted audio label and downloading and/or printing via buyers computer printing devices, detailed diagramed instructions for assembling unfabricated “record/card” as diagramed in FIG. 1 herein and as it pertains to “the Patent” and its drawings (FIGS. 1 & 2), descriptions thereto and descriptions of the preferred embodiments therein.

15] A method pursuant to claim 14 of alternatively receiving un-fabricated “record/card” via postal methods comprising elements for assemblage comprising pre-designed “record/card” template “cut-out”, instructions for fabricating “record/card” as described and diagramed in FIG. 1 instructions; pre-recorded audio disc; pre-printed audio label; and pre-sized mailing envelope for buyer's sending to a selected recipient.

16] A method according to claim 15 of assembling downloaded “cut-out” of “e-record/card” further comprising instructions for fabrication of such configuration

17] A method according to claim 7 of creating an “animated e-record/card.

18] A method according to claim 16 of purchasing “animated e-record/card” via transactional purchasing system on seller's web site; the sending to buyer's selected recipient via e-mail interface over public communications devices; an interface for recipient comprising instructions for playing back audio with simultaneous visual viewing, further comprising interface and instructions for downloading and/or saving such configuration.

19] A method according to claim 18 of receiving “animated record/card” and e-mail interface comprising an audio/visual input device and further comprising a method of displaying “animation” comprising disc turning round within “e-record/card”, along with simultaneous audio playback via recipient's computer audio devices, further displaying opening of “record/card” and revealing textual sentiment, and further comprising interface for recipient's downloading and saving said “animated e-record/card”, or as may be further modified or varied and should be construed as included in the scope of the claim as it pertains to the present invention, which would be apparent to those skilled in the art.

20] A method according to claim 1 and with respect to Summary Of Invention hereto of making the “e-record/card” present invention marketing-profitable, comprising the contents therein, including text, headings, subheading, the methods of brick & mortar and e-commerce retailing and licensing and as further illustrated in FIG. 2 of the present invention.
